(19) United States
(12) Patent Application Publication
(10) Pub. No.: US 2006/0289573 A1
(43) Pub. Date: Dec. 28, 2006

(54) Device for Lifting and Carrying Injured or Disabled Persons

(75) Inventors: Vivencio Lacerna Mantuano Jr., Norfolk, VA (US); Desmond Obrian Strachan, Jacksonville, NC (US)

Correspondence Address: Vivencio L. Mantuano Jr., 1208 Evelyn St., Norfolk, VA, 23518-2620, US

(73) Assignees: Vivencio L. Mantuano JR., Norfolk, VA (US); Desmond Obrian Strachan, Jacksonville, NC (US)

(21) Appl. No.: 11/160,480

(22) Filed: Jun. 27, 2005

(51) Int. Cl. A45F 3/14; A61G 1/00; A61G 5/00

(52) U.S. Cl. 224/157

(57) ABSTRACT

A device used as a lifting and carrying device is disclosed. The device is made of flexible material and is configured in such a way to support a person or object, such as a long backboard used by EMS personnel. The device is configured in a basic “X” configuration including carrying loops at all four ends of the device. Additionally, there are two pieces of flexible material affixed to the “X” that intersect with the “X” at various points on the “X” and are generally parallel to each other. Both of these pieces of flexible material also have carrying loops on each end and extend outward from the “X”. Another piece of flexible material that is generally parallel with the pieces that extend from the “X” is permanently affixed to the “X” for the purpose of supporting a person's legs while being carried. A piece of flexible material is affixed to and intersects with the “X” for the purpose of supporting a person's head while being carried. This device is placed underneath a person or object. Up to sixteen people can lift the person or object using the carrying loops.

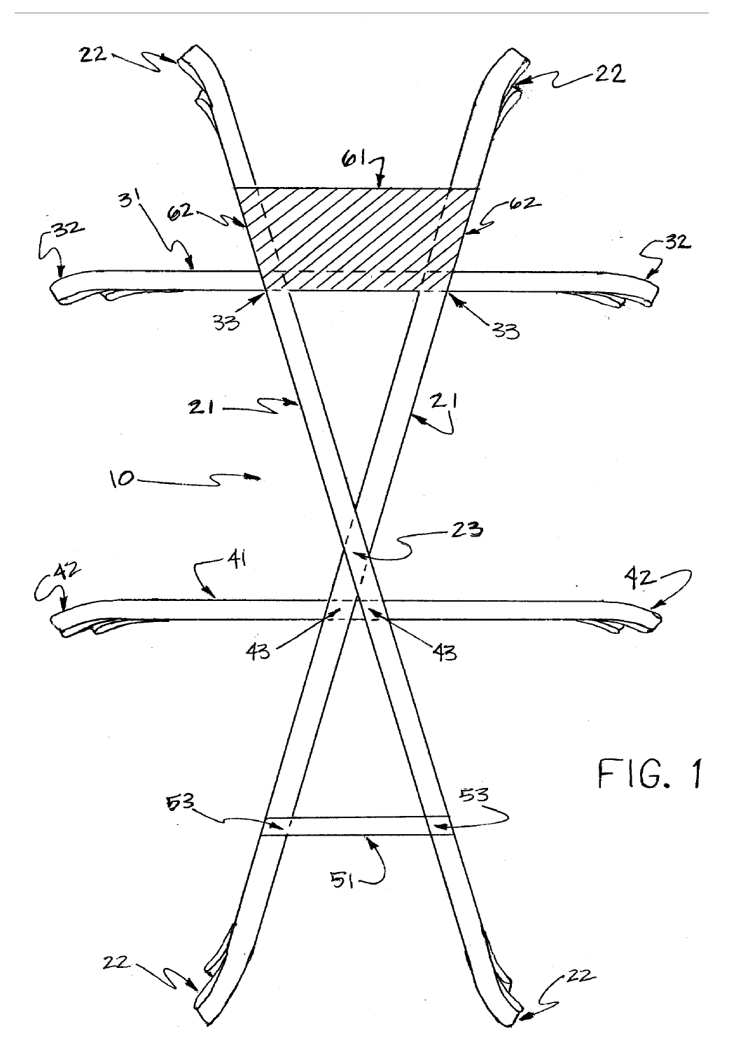

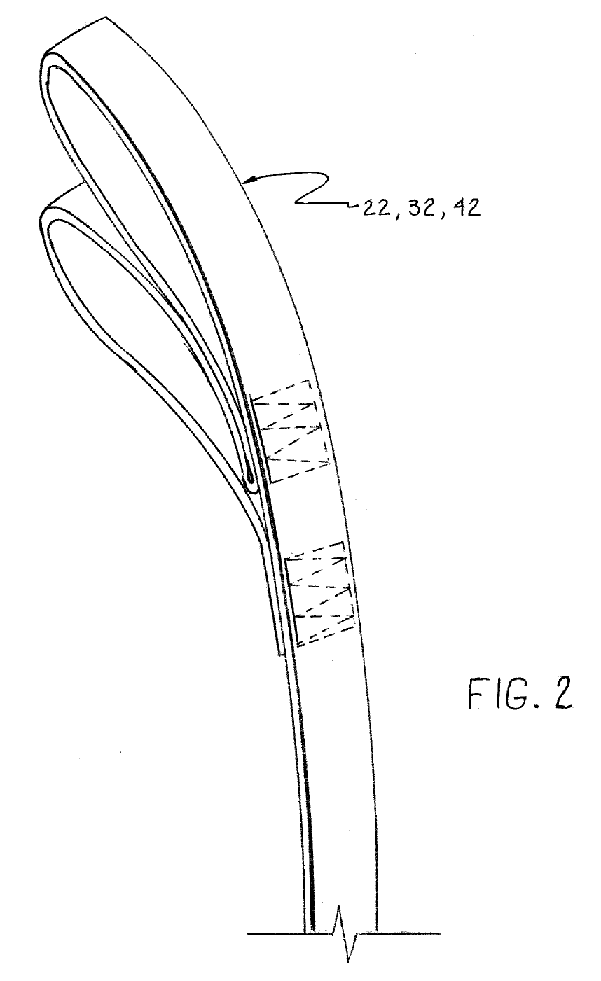

### DESCRIPTION

The present invention relates generally to devices for lifting and carrying people and related rescue equipment, and more specifically to a device that enables rescue personnel to lift and carry an injured or disabled person. This invention is light-weight, portable, easily stored, and machine-washable.

Frequently in the field of emergency medicine, emergency medical technicians (EMT^{s}), firefighters, and public safety officers are required to lift and carry injured or disabled patients of large stature, which is usually accomplished by grabbing the patient's limbs or clothing. While the rescuers are able to accomplish these lifts, there are inherent risks that account for many job-related injuries. Utilizing these methods to lift and carry a person may lead to injuries to patients as well. Most injuries suffered by rescuers and patients could be avoided with the use of this invention and proper lifting techniques.

While the primary use of this device is focused toward EMS personnel, other professions will find it equally useful. In fact, the use of our invention may prove invaluable to members of the Federal Emergency Management Agency (FEMA) in the event of a Mass Casualty Incident (MCI). Because no special skill is required to utilize the device, FEMA rescuers and lay persons alike would be able to effectively deploy it to help extricate victims of an MCI without any specialized training or use of any other devices. Similarly, soldiers and corpsmen on battlefields must carry deceased or wounded casualties. These tasks must be accomplished with extreme urgency in order to ensure the safety of the rescuers while they transport the victim to a safe location for medical attention and may also have to be carried out over long distances. The use of this invention would make it easier for troops to carry the wounded or deceased with minimal fatigue and decreased risk of exposure to enemy attack. Because of its small size, it can easily fit into a pouch or cargo pocket and may possibly be integrated into the combat uniform.

What is claimed is:

1. a person or object carrying device (10), comprising:
a. two primary pieces of flexible material (21) in the configuration of an “X” wherein:
i. the two primary pieces of flexible material are permanently attached to one another at a single point (23) in the configuration of an “X”, wherein:
1. the point at which the two primary pieces of flexible material intersect (23) are attached using a zigzag stitch pattern
ii. there is a plurality of loops (22) at each end of the two primary pieces of flexible material (21), wherein:
1. each loop (22) is formed as a continuation of the piece of material (21) wherein:
a. each loop (22) is stitched with a zigzag stitch pattern
iii. the two primary pieces of flexible material (21) are relatively equal in length
b. a secondary piece of flexible material (31) that intersects with and is attached to the “X” at two points (33), wherein:
i. there is a plurality of loops (32) at each end of this secondary piece of flexible material (31), wherein:
1. each loop (32) is formed as a continuation of the secondary piece of material (31), wherein:
a. each loop (32) is stitched using a zigzag stitch pattern
c. a tertiary piece of flexible material (41) that intersects with and is attached to the “X” at two points (43), wherein:
i. there is a plurality of loops (42) at each end of this tertiary piece of flexible material (41), wherein:
1. each loop (42) is formed as a continuation of the tertiary piece of flexible material (41), wherein:
a. each loop (42) is stitched using a zigzag stitch pattern
ii. the tertiary piece of flexible material (41) is generally parallel to the secondary piece of flexible material described in 1.b (31)
d. a piece of flexible material (51) that intersects with and is attached to the “X” at two points (52) and is generally parallel with the two pieces described in 1.b and 1.c (31 and 41) for the purpose of supporting a person's legs when being lifted or carried
e. a piece of flexible material (61) that intersects with and is attached to the “X” at two points (62) and is attached to the secondary piece of flexible material described in 1.b (31) for the purpose of supporting a person's head while being lifted or carried.

2. a method of utilizing the device (10) described in claim 1, wherein:
a. the device (10) is placed under an injured or disabled person, wherein:
i. the primary pieces of flexible material described in 1.a (21) configured in an “X” configuration are positioned in a relatively parallel axis to the body of the person to be lifted or carried
ii. the secondary piece of flexible material described in 1.b (31) is positioned so that it rests generally beneath the shoulder blades of the person to be lifted or carried
iii. the tertiary piece of flexible material described in 1.c (41) is positioned so that it rests generally beneath the hips of the person to be lifted or carried
iv. the piece of flexible material described in 1.d (51) is positioned so that it rests generally beneath the legs of the person to be lifted
v. the piece of flexible material described in 1.e (61) is positioned so that it rests generally beneath the legs of the person to be lifted
b. each lifter inserts his or her hand completely through one or more of the loops and grasps the flexible material that forms the loop through which the lifter inserts his or her hand
c. each lifter lifts in a generally straight upward motion, thus suspending the person to be lifted or carried above the ground.
